(19) United States
(12) Patent Application Publication
(10) Pub. No.: US 2025/0234870 A1
(43) Pub. Date: Jul. 24, 2025

(54) SERPENTINE OVEN CONVEYOR

(71) Applicant: Kernel Foods, Inc., New York, NY (US)

(72) Inventor: John Lawrence GOERS, Centennial, CO (US)

(21) Appl. No.: 19/035,452

(22) Filed: Jan. 23, 2025

Related U.S. Application Data
(60) Provisional application No. 63/624,229, filed on Jan. 23, 2024.

(51) Int. Cl. A21B 1/46; B25J 9/00; B65G 17/12; B65G 47/90

(52) U.S. Cl. CPC A21B 1/46; B65G 17/12; B65G 47/90; B25J 9/0093; B65G 2201/0202; B65G 2812/02762

(57) ABSTRACT

Some embodiments described herein relate to a platform that is configured to be disposed in an oven in a horizontal orientation. Multiple receptacles, each configured to receive a food item, can be positioned above the platform. The receptacles can be coupled to and driven by a chain, cable, belt, or other suitable mechanism parallel to and disposed below the platform. The chain, cable, belt, etc. can mesh with sprockets, pulleys, etc. coupled to a plurality of axels such that the chain, cable, belt, etc. can move the receptacles in a closed loop.

### CROSS REFERENCE TO RELATED APPLICATIONS

The present application claims priority to and benefit of provisional U.S. Patent Application No. 63/624,229, filed on Jan. 23, 2024 “Serpentine Oven Conveyor” which is incorporated by reference herein.

### FIELD

The present application generally relates to kitchen automation, including serpentine oven conveyors particularly suited for use with robotic arms configured to deposit and/or retrieve food for cooking.

### BACKGROUND

Cooking has long been a labor-intensive activity, and therefore there has been a long history of efforts to increase automation and reduce manual activity and/or other inefficiencies. For example, there are known conveyor-based ovens that automatically move food items through a heated oven. Such ovens, however, are typically designed for manual load and unload and are not well suited for integration with robotics. For example, known conveyor-based ovens typically have a relatively wide conveyor belt that allows and encourages multiple food items to be loaded perpendicular to the direction of the belt's travel, which can be difficult to accommodate for robots. In particular, in instances when different types of food (e.g., different orders, such as a cheese pizza and a pepperoni pizza) are running through the oven simultaneously (or nearly simultaneously).

Conveyor-based ovens can be broadly divided into two categories, vertical and horizontal. Horizontal ovens are widely commercially available and are regular features in pizza and sandwich shops. Known horizontal conveyor ovens include a continuously running conveyor configured to be loaded on one end and unloaded on the other. This presents a substantial obstacle to further automation, as a single robot cannot readily perform both the load and unload operations and multiple robots represents a substantially increased cost and footprint. Alternatively, some horizontal reciprocating designs allow a food item to be loaded on one end, slid into the oven, and reversed out on the same side. Reciprocating ovens, however, have relatively low throughput and are typically unsuitable for high-volume food production due to form factor & spatial requirements if they were to be integrated with automation. Vertical ovens are typically custom fabricated and used in industrial-scale food production, such as very large bakeries. Vertical conveyor ovens typically require a large initial capital outlay, substantial available vertical space, and are not well suited for on-demand cooking or relatively small restaurant kitchens. Some such ovens may allow for loading and unloading at a single location or nearby locations but are typically designed for volume loading and are unsuitable for single-item loading and unloading, making the preparation of different item types, custom, and/or to-order dishes difficult or infeasible. For example, as discussed above, such ovens typically have wide belts (perpendicular to the direction of travel) allowing multiple food items to loaded horizontally on the belt. Thus, because such ovens are typically designed to be loaded via upstream conveyors and unloaded to downstream conveyors, it can be challenging or impossible for a robot to consistently locate and retrieve a single food item, given that such a food item can be placed anywhere along the width of the belt.

A need therefore exists for a horizontal oven suitable for restaurant-scale kitchens that are amenable to robotic and/or manual loading and unloading to reduce manual labor requirements and improve throughput.

### BRIEF DESCRIPTION OF THE DRAWINGS

FIG. 1A is a perspective view and a top view, respectively, of an oven and a robot, according to an embodiment.

FIG. 1B is a top view of the oven and robot of FIG. 1A.

FIG. 1C is an alternative perspective view of the oven of FIG. 1A.

FIG. 2A is a top view of conveyor, according to an embodiment.

FIG. 2B is a perspective view of the conveyor of FIG. 2A.

FIG. 2C is a top section view of the conveyor of FIG. 2A.

FIG. 3 is a flow chart of a method, according to an embodiment.

### DETAILED DESCRIPTION

Some embodiments described herein relate to a platform that is configured to be disposed in an oven in a horizontal orientation. Multiple receptacles, each configured to receive a food item, can be positioned above the platform. The receptacles can be coupled to and driven by a chain, cable, belt, or other suitable mechanism parallel to and disposed below the platform. The chain, cable, belt, etc. can mesh with sprockets, pulleys, etc. coupled to a plurality of axels such that the chain, cable, belt, etc. can move the receptacles in a closed loop.

Some embodiments described herein relate to a method that includes loading a receptacle with a food item using a robotic arm. The receptacle containing the food item can be conveyed through an oven via a serpentine path, such that the receptacle changes direction at least three times within the oven. The receptacle can be unloaded from the receptacle after being conveyed through the oven using the robotic arm.

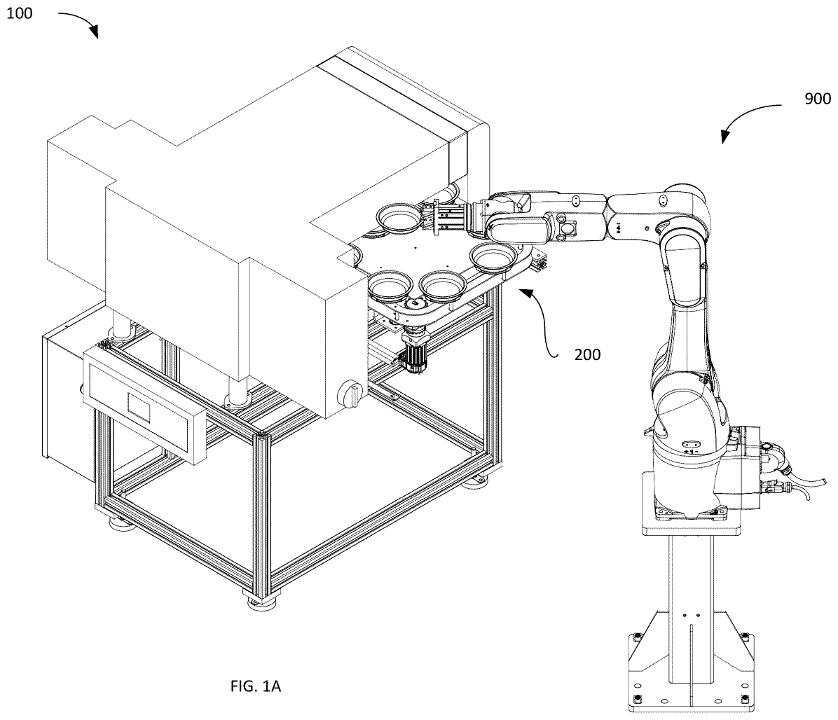

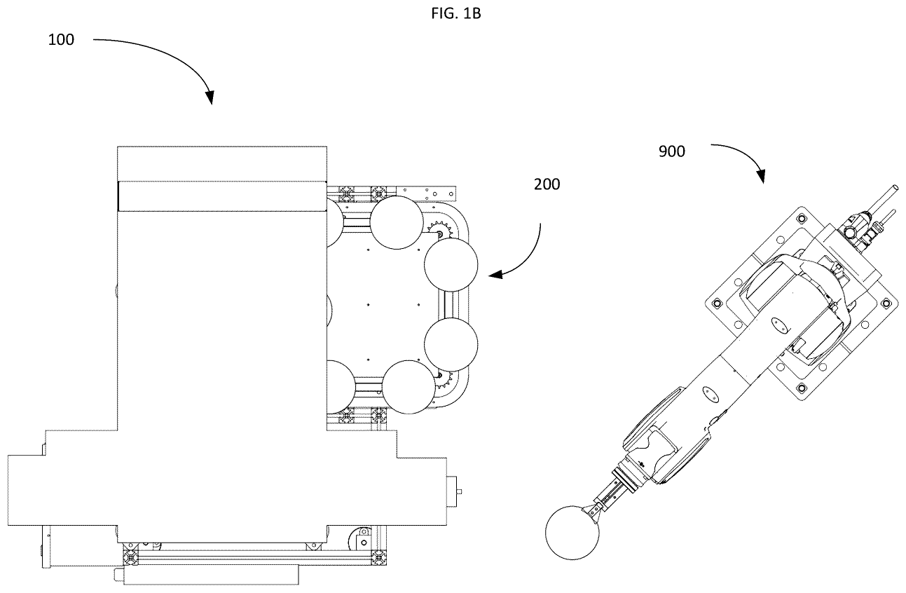

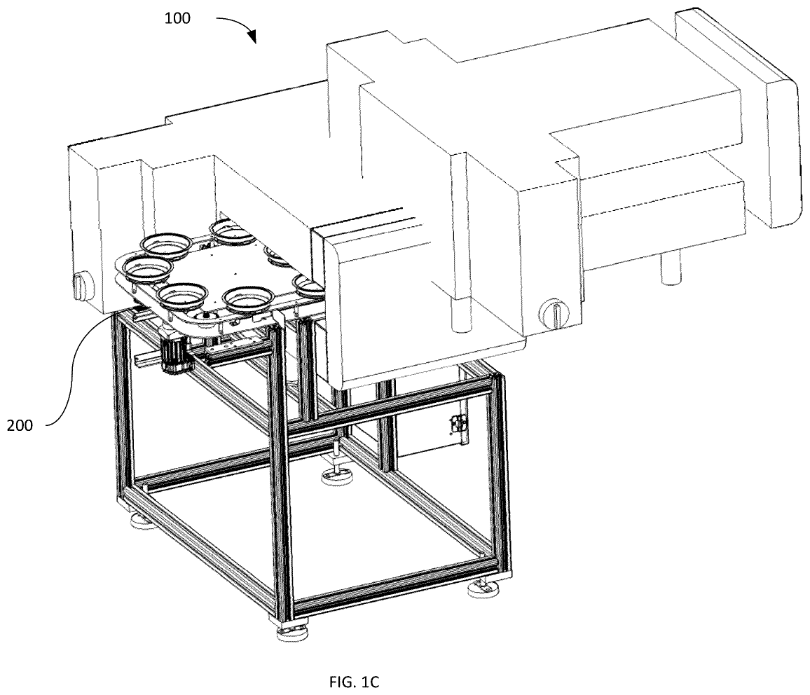

FIGS. 1A and 1B depict a perspective view and a top view, respectively, of an oven 100 and a robot 900, according to an embodiment. FIG. 1C is an alternate perspective view of oven 100. The oven 100 can be a horizontal oven with a specialized conveyor 200. The oven 100 can be particularly well suited for compact commercial kitchens and may not require an exhaust hood. The robot 900 can be a commercially available multi-axis robot, such as a six-axis articulating robotic arm.

The oven 100 can be any suitable cooking appliance. In some embodiments, oven 100 can be a commercially available oven originally designed with a pass-through conveyor system. In some embodiments, the oven 100 can be a ventless impingement oven. Such ovens can be particularly well suited for small commercial kitchens and may be safely operated without a hood. For example, an example oven can have a footprint of approximately 2 feet by 4 feet. Such ovens typically have a grated conveyor belt that passes food items from an inlet side, through the oven where the food item is heated, to an outlet side. Such ovens are particularly well suited for cooking pizzas, sandwiches, or other food items. Ovens with standard grated conveyors, however, may not be suitable for automation because the food item exits on the opposite side on which it is loaded, which may require two robots or manual loading or unloading.

Embodiments described herein generally relate to the oven 100 having conveyor 200, which allows the food items to enter and exit the oven 100 on the same side such that robot 900 can automatically load uncooked, partially cooked, chilled, and/or room temperature food items and unload cooked, heated, and/or reheated food items at the same or a nearby location. In some embodiments, the robot 900 can be communicatively coupled to an ordering system such that the robot 900 can retrieve a specific pre-prepared food item from a loading area based on an individual customer order. Similarly stated, the robot 900 can be operable to select a type of food item to load onto the conveyor 200 based on an individual customer order.

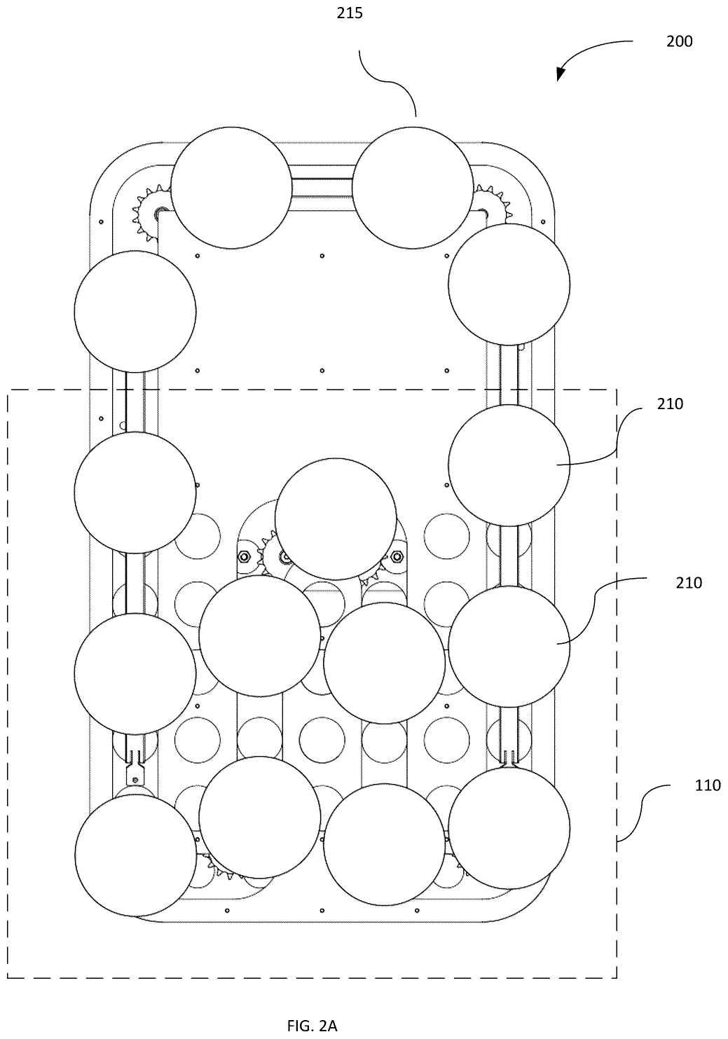

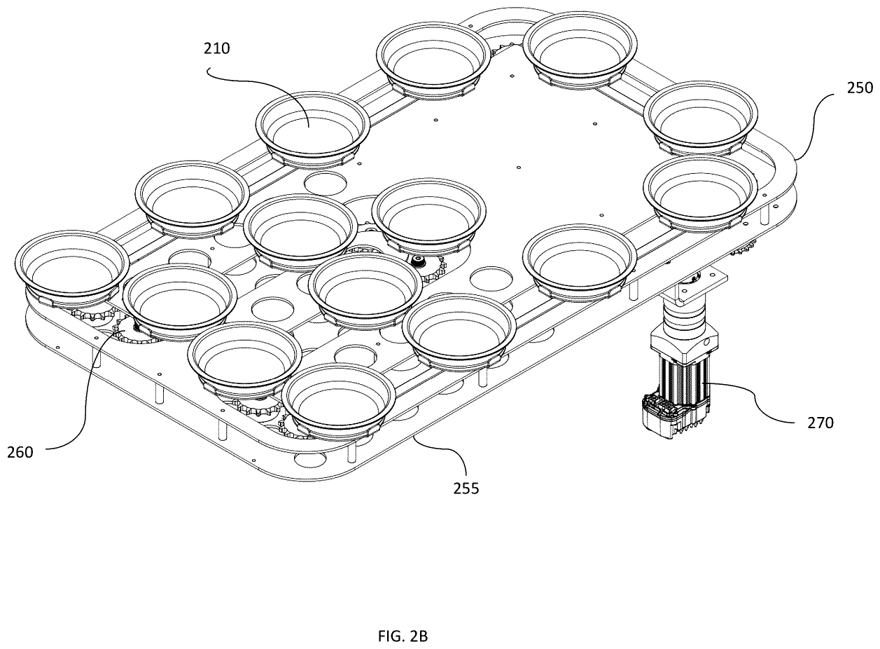

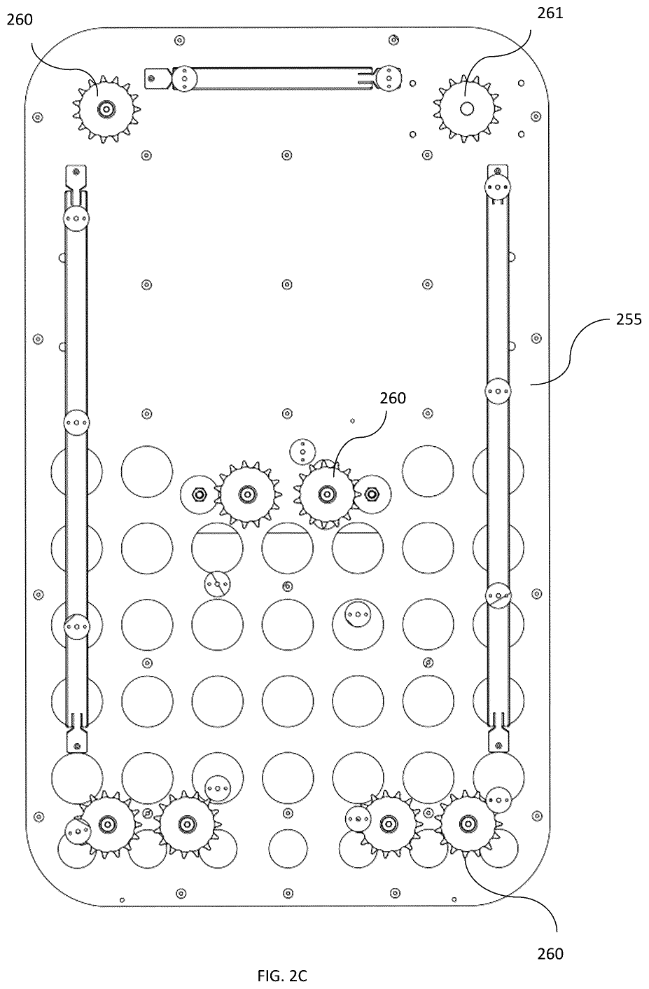

FIG. 2A is a top view of conveyor 200, according to an embodiment. Conveyor 200 has multiple receptacles 210, each configured to hold a food item and carry it through oven 100. The receptacles 210 can be configured to hold the same food items, different types of food items, food items of a predetermined size and/or food items of different sizes. Each food item can be loaded and unloaded on a single side of the oven 100, for example at load point 215. As discussed in further detail herein, this allows a one-dimensional, first-in/first-out (FIFO) movement of food items through the oven, which can be beneficial for automation by allowing robot 900 to consistently locate food items at a single location (e.g., load point 215) and/or along a single closed loop path.

In a cooking zone 110 (e.g., the portion of conveyor 200 within or configured to be within oven 100), the closed loop path can take a serpentine or circuitous route, including one or more switchbacks, zig-zags, or other changes of direction, such that the distance a receptacle 210 travels within the cooking zone 110 is greater than a perimeter of a top plate 210 of the conveyor 200. This can increase dwell time (for a given chain drive speed speed) and increase capacity of the conveyor 200. Thus, in addition to allowing loading and unloading on a single side of the oven 100 and providing one-dimensional flow of food items, conveyor 200 can increase the effective capacity of the oven 100. Similarly stated, while it may be possible to load a standard two-dimensional pass-through conveyor with the same number of food items as load points 215 within the oven portion 210 of the conveyor, to do so would require loading and unloading multiple items that are cooked in parallel substantially simultaneously, which may be difficult or impossible to automate and challenging to consistently accomplish manually.

FIG. 2B is a perspective view of conveyor 200. Conveyor 200 includes a top plate 250 and a bottom plate 255. FIG. 2C is a top section view of conveyor 200 with top plate 250 and receptacles 210 removed. A portion of each receptacle 210 can be coupled to a chain drive or other type of flexible power transmission device, such as a cable (not shown) that defines the path of the receptacles 210. Sprockets 260, axles, and/or pulleys can mesh with the chain drive or cable and guide its path through conveyor 200. As shown, the conveyor 200 includes eight sprockets 260, such that the chain drive, and therefore the closed path traversed by the receptacles 210, is serpentine or circuitous. The chain drive, and therefore receptacles 210, can make 90 degree turns (about the radii of the sprockets 260) at the upper right and upper left portions of the conveyor 200, as shown in FIG. 2C, in the loading and unloading zone (e.g., the portion of the conveyor that is disposed outside the oven). Within the cooking zone 110, the chain drive, and therefore receptacles 210, can make two hairpin turns around pairs of sprockets 260, increasing the travel distance in the cooking zone 110.

It should be understood that the specific layout of the sprockets and path shown is an example only. In other embodiments, as few as two sprockets, axles, and/or pulleys can define an oval-shaped path for the receptacles. Any other suitable number of sprockets, axles, and/or pulleys, such as three (defining a triangle) or four (defining a quadrilateral) is possible. It may be preferable, however, for conveyors to have at least five sprockets, axles, and/or pulleys such that the chain or cable drive forms a shape having at least one turn of more than 90 degrees, increasing the travel distance of receptacles 210 beyond the length of the perimeter of the top plate 255.

A drive sprocket 261, axle, and/or pulley can be coupled to a motor 270, such that that motor can drive the chain drive or cable and cause the receptacles 210 to move along the serpentine path. In use, a controller can operate motor 270. Controller can further be coupled to a switch that detects passing receptacles, an encoder, and/or any other suitable sensor capable of determining the state (e.g., speed and/or position) of one or more receptacles 210. The controller can be configured to stop the motor 270 (and therefore the chain drive and/or receptacles 210) when a receptacle 210 reaches the load point 215. The controller can further be communicatively coupled to the robot 900 and send a signal to cause the robot to retrieve a cooked food item from the receptacle 210 at the load point 215 and/or deposit an uncooked food item on the receptacle 210. For example, when a receptacle 210 reaches the load point 215, the motor 270 can stop the chain drive and the robot 900 can move to the load point 215, pick up the cooked food item, move the cooked food item to a finishing station, then move to a rack of prepared uncooked food items, pick up an uncooked food item, move back to the load point 215, deposit the uncooked food item on the receptacle 210 at the load point, and then the controller can send a signal to cause the motor 270 to start, moving the uncooked food item along the serpentine path, away from the load point 215, and towards the cooking zone 110. This process can be repeated as each receptacle 210 reaches load point 215. In some instances, the elapsed time from motor stop to motor start can be less than 20 seconds, less than 45 seconds, less than 10 seconds, or less than 5 seconds. Generally, the elapsed time from motor stop to motor start is a function of the time required for the robot 900 to remove a food item from a receptacle 210, place it in an unload area, retrieve a food item from a load area, and load it onto the receptacle. In some embodiments, the controller can further track which receptacles 210 are loaded with food items (e.g., in some instances the conveyor 200 may not be loaded to capacity) and only stop the conveyor 200 when a receptacle 210 containing a cooked food item is at the load point 215 and/or when a request to cook a food item is received. In some embodiments, the controller can be configured to change the speed of the motor 270 based on food items loaded onto receptacles and/or desired cook times. In other embodiments, the controller can operate the motor 270 at a constant speed (e.g., to drive the chain drive at approximately 8 inches per second, or any other suitable speed) for example, when the same food item is cooked repeatedly and/or when serving sizes of different food items are prepared to have equal cook times.

In some embodiments the conveyor 200 can be operable to be removably inserted into the oven. For example, the conveyor 200 can be coupled to the oven via rails or sliding tracks. In such an embodiment, the entire conveyor 200 can be removed from the oven for cleaning. In some such instances, the motor 270 can be removeably coupled to the drive sprocket 261 and the remaining conveyor components (e.g., receptacles 210, sprockets 260, top plate 250, and a bottom plate 255) can be cleaned as a unit.

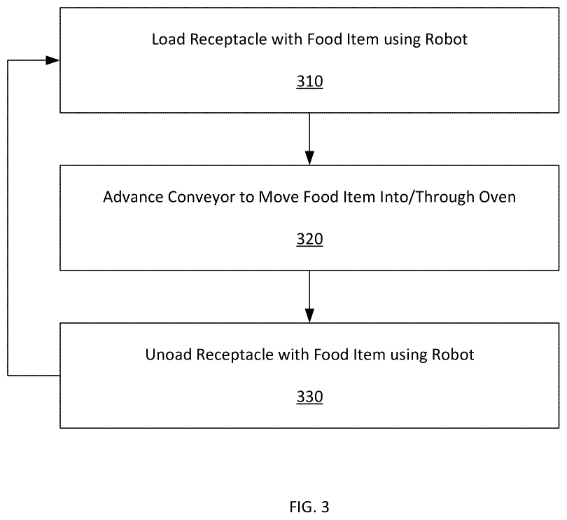

FIG. 3 is a flow chart of a method, according to an embodiment. At 310 a food item can be loaded onto a first receptacle using a robot, such as a six-axis robotic arm. The robot can be operable to retrieve the first food item from a load/staging area and move to place the first food item at the first receptacle.

At 320, a conveyor can be advanced to move the first food item into and/or through the oven. For example, the conveyor can be structurally and/or functionally similar to conveyor 200 discussed above with reference to FIG. 2. The conveyor can follow a serpentine path through the oven, such that the receptacle changes direction at least three times within the oven.

In some embodiments, a motor driving the conveyor and/or an encoder can be communicatively coupled to a controller, such that the controller can be operable to determine and/or track a position of the first receptacle and the first food item (and any other receptacles and/or food items) as they transit the oven. The motor can, in some embodiments, be a stepper motor operable to advance the conveyor one position at a time, such as the length between receptacles, so that after each step of advancement a new receptacle is located at a designated load/unload area where food items can be retrieved and/or deposited by the robotic arm.

For example, after advancing the conveyor a single step, such that a subsequent receptacle is located in the load/unload area, the robotic arm can retrieve a second (cooked/heated) food item that has transited the oven. The robotic arm can then retrieve a third food item and deposit the third food item in the second receptacle, and the conveyor can be advanced an additional step. This process can be repeated until the first food item completes the closed loop of the conveyor transit through the oven and returns to the load/unload point, where the robotic arm can retrieve the first food item from the first receptacle, at 330.

The first food item can be deposited in an unload area/staging area, where it can be retrieved by a human operator and/or another robot and moved for subsequent finishing operations and/or packaged for delivery to a customer. In some instances, from retrieving the food item at 310 to delivering the food item at 330, the method can be performed without human intervention. For example, in some instances, human operators can fill a staging area with uncooked food items for retrieval by the robotic arm and can retrieve cooked items delivered by the robotic arm at an unload area, but may not interfere with or otherwise be involved with the operation of the robot, which can operate autonomously according to its programming (which may include selecting particular food items to deposit into receptacles based on customer orders).

While various embodiments have been described above, it should be understood that they have been presented by way of example only, and not limitation. Furthermore, although various embodiments have been described as having particular features and/or combinations of components, other embodiments are possible having a combination of any features and/or components from any of embodiments where appropriate as well as additional features and/or components.

Some embodiments described herein relate to methods and/or processing events, for example, methods of operating the motor 270 and/or robot 900. It should be understood that such methods and/or processing events can be computer-implemented. That is, where method or other events are described herein, it should be understood that they may be performed by a compute device having a processor and a memory. For example, some embodiments discussed above relate to a controller communicatively coupled to motor 270 and/or robot 900. Such a controller can be any suitable compute device, including a stand-alone computer, a cloud-based service, and/or completely and/or partially integrated with motor 270 and/or robot 900.

Memory of a compute device is also referred to as a non-transitory computer-readable medium, which can include instructions or computer code for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules, Read-Only Memory (ROM), Random-Access Memory (RAM) and/or the like. One or more processors can be communicatively coupled to the memory and operable to execute the code stored on the non-transitory processor-readable medium. Examples of processors include general purpose processors (e.g., CPUs), Graphical Processing Units, Field Programmable Gate Arrays (FPGAs), Application Specific Integrated Circuits (ASICs), Digital Signal Processor (DSPs), Programmable Logic Devices (PLDs), and the like. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

Where methods described above indicate certain events occurring in certain order, the ordering of certain events may be modified. Additionally, certain of the events may be performed concurrently in a parallel process when possible, as well as performed sequentially as described above.

What is claimed is:

1. An apparatus, comprising:
a platform configured to be disposed in an oven in a horizontal orientation;
a plurality of receptacles, a first portion of each receptacle from the plurality of receptacles disposed above the platform and configured to receive a food item from a plurality of food items;
a plurality of axles; and
at least one of a chain, a cable, or a belt meshing with at least one of a sprocket or a pully coupled to each axle from the plurality of axles such that the at least one of the chain, the cable, or the belt is disposed in a plane that is parallel to and beneath the platform, a second portion of each receptacle from the plurality of receptacles coupled to the chain, the cable, or the belt such that the chain, the cable, or the belt can move the plurality of receptacles in a closed loop.

2. The apparatus of claim 1, wherein the plurality of axles includes at least three axles such that the closed loop traverses a serpentine path.

3. The apparatus of claim 1, wherein the plurality of axles includes at least five axles such that the closed loop traverses a serpentine path.

4. The apparatus of claim 1, further comprising a robot configured to load and unload each food item from the plurality of food items to and from a receptacle from the plurality of receptacles at a single load/unload location.

5. The apparatus of claim 4, wherein the robot is one articulated robot.

6. The apparatus of claim 1, wherein the plurality of receptacles transit the closed loop in a first-in/first out-pattern,

7. The apparatus of claim 1, further comprising the oven, the oven being a ventless impingement oven.

8. A method, comprising:
loading a receptacle with a food item using a robotic arm;
conveying the receptacle containing the first food item through an oven via a serpentine path such that the receptacle changes direction at least three times within the oven; and
unloading the food item from the receptacle using the robotic arm after conveying the receptacle through the oven.

9. The method of claim 8, wherein the robotic arm loads the receptacle and unloads the receptacle on one side of the oven.

10. The method of claim 8, wherein the robotic arm loads the receptacle and unloads the receptacle when the receptacle is at a single location on the serpentine path.

11. The method of claim 8, wherein the food item is a first food item loaded onto a first receptacle, the method further comprising:
loading a second receptacle with a second food item using the robotic arm after partially conveying the first receptacle through the oven, the first receptacle and the second receptacle each coupled to at least one of a chain, a cable, or a belt such that conveying the first receptacle through the oven also conveys the second receptacle through the oven via the serpentine path.

12. The method of claim 8, wherein the food item is a first food item loaded onto a first receptacle, the method further comprising:
loading a second receptacle with a second food item using the robotic arm after partially conveying the first receptacle through the oven, the first receptacle and the second receptacle each coupled to at least one of a chain, a cable, or a belt such that conveying the first receptacle through the oven also conveys the second receptacle through the oven via the serpentine path; and
unloading the second food item from the second receptacle using the robotic arm after unloading the first food item from the first receptacle.

13. The method of claim 12, wherein the first receptacle and the second receptacle traverse the serpentine path in a first-in/first-out pattern.

14. The method of claim 8, wherein the food item is conveyed through the oven entirely in a horizontal plane.

15. The method of claim 8, further comprising retrieving the food item from a load area via the robotic arm.

16. The method of claim 8, further comprising depositing the food item into an unload area via the robotic arm.

17. The method of claim 8, further comprising:
retrieving the food item from a load area via the robotic arm before loading the receptacle; and
depositing the food item in an unload area via the robotic arm.

18. The method of claim 17, wherein the foot item is retrieved from the load area, is conveyed through the oven, and deposited in the unload area without human intervention.

19. The method of claim 8, wherein the receptacle is coupled to at least one of a chain, a cable, or a receptacle that pulls the receptacle through the oven via the serpentine path.

20. The method of claim 8, wherein:
the receptacle is coupled to at least one of a chain, a cable, or a belt that pulls the receptacle through the oven via the serpentine path; and
the chain, the cable, or the belt meshes with at least one of a sprocket or a pully configured to drive the chain, the cable, or the belt.

21. The method of claim 8, wherein:
the receptacle is coupled to at least one of a chain, a cable, or a belt that pulls the receptacle through the oven via the serpentine path;
the chain, the cable, or the belt meshes with at least one of a sprocket or a pully configured to drive the chain, the cable, or the belt; and
the chain, the belt, or the pully is coupled to at least five axels that route the chain, the belt, or the pully through the serpentine path.
